(19) United States
(12) Patent Application Publication
(10) Pub. No.: US 2016/0318689 A1
(43) Pub. Date: Nov. 3, 2016

(54) DISPENSING INGREDIENTS FROM A BEVERAGE CARTRIDGE

(71) Applicant: THE COCA-COLA COMPANY, Atlanta, GA (US)

(72) Inventors: Arthur Rudick, Atlanta, GA (US); Brad Green, Dacula, GA (US)

(73) Assignee: THE COCA-COLA COMPANY, Atlanta, GA (US)

(21) Appl. No.: 15/107,553

(22) PCT Filed: Dec. 22, 2014
(86) PCT No.: PCT/US2014/071928

§ 371 Date: Jun. 23, 2016

Related U.S. Application Data
(60) Provisional application No. 61/920,158, filed on Dec. 23, 2013.

(51) Int. Cl. B65D 81/32; A47J 31/44; B65D 85/804; A47J 31/36; B65D 25/04; A47J 31/40; A47J 31/46

(52) U.S. Cl. CPC B65D 81/32; A47J 31/405; A47J 31/407; A47J 31/4492; A47J 31/46; A47J 31/3623; B65D 25/04; B65D 85/804

(57) ABSTRACT

A cartridge for use in a beverage dispenser. The cartridge including a plurality of storage compartments stacked one on top of the other within an interior of the cartridge. Each of the plurality of storage compartments includes an inlet port, an outlet port opposite the inlet port, an ingredient contained between the inlet and outlet ports, and a seal covering the inlet and outlet ports. A transfer medium ruptures the seal and enters the inlet port to discharge the ingredients simultaneously out of each of the plurality of storage compartments.

### CROSS REFERENCE TO RELATED APPLICATIONS

This application is a U.S. National stage application of International Application PCT/US2014/071928, filed on Dec. 22, 2014, which claims the benefit of U.S. Provisional Patent Application 61/920,158, filed Dec. 23, 2013, the disclosures of which are incorporated by reference in their entirety.

### BACKGROUND

Several different types of beverage brewing systems are known in the art. For example, percolators and drip-type coffee makers have been used to make regular or “American”-type coffee. Hot water is generally passed through a container of coffee grinds so as to brew the coffee. The coffee then drips into a pot or a cup. Likewise, pressure-based devices have been used to make espresso-type beverages. Hot, pressurized water may be forced through the espresso grinds so as to brew the espresso. The espresso may then flow into the cup.

Various beverage brewing systems use beverage pods to dispense individual servings quickly and conveniently. The single serving beverage brewing pods are popular and typically comprise a sealed container having a top surface, a bottom surface and a filter. Some other pods may be used for preparing beverages or other food products which contain a water soluble substance. The water soluble substance may be a liquid or powdered ingredient for making a beverage such as coffee, tea or soup, fruit juice and desserts.

### SUMMARY

In general terms, this disclosure is directed to a method and apparatus for operating an automated dispenser to dispense hot brewed beverages, cold still beverages, and/or cold carbonated beverages using pods with similar external geometries. In one possible configuration and by non-limiting example, the cartridge includes a plurality of storage compartments stacked in series within an interior of the cartridge. Each of the plurality of storage compartments includes an inlet port, an outlet port opposite the inlet port, an ingredient contained between the inlet and outlet ports, and a seal covering the inlet and outlet ports. The cartridge can be configured to allow a transfer medium to rupture the seal of each of the storage compartments and to enter the inlet port to dilute the ingredient in each storage compartment in series and to discharge the diluted ingredients out of the cartridge.

Another aspect is a beverage dispenser including a cartridge having a plurality of storage compartments stacked on top of one another. Each of the plurality of storage compartments include an inlet port; an outlet port opposite the inlet port; an ingredient contained between the inlet and outlet ports; and a seal covering the inlet and outlet ports. The beverage dispenser further includes a turret including a first station for dispensing a carbonated beverage from a cartridge that has been inserted into the beverage dispenser; a first dispensing head and a second dispensing head adjacent to the first dispensing head. The first and second dispensing heads are arranged and configured to move laterally such that one of the first and second dispensing heads is positioned over the first dispensing station for dispensing therefrom.

### DESCRIPTION OF THE DRAWINGS

FIG. 1 is a perspective view of an example beverage dispenser in accordance with the principles of the present disclosure.

FIG. 2 is schematic top plan view of an example beverage dispenser configured to dispense coffee in accordance with the principles of the present disclosure.

FIG. 2A is a cross-sectional view of a portion of the beverage dispenser shown in FIG. 2 taken along line 2A-2A.

FIG. 3 is a schematic top plan view of the example beverage cooling system shown in FIG. 2 configured to dispense carbonated soft drinks (CSDs).

FIG. 3A is a cross-sectional view of a portion of the beverage dispenser shown in FIG. 3 taken along line 3A-3A.

FIG. 3b is a schematic view of an example control system for the beverage dispenser of FIG. 1.

FIG. 4 is a schematic top plan view of a turret having two dispensing heads in accordance with the principles of the present disclosure.

FIG. 5 is a schematic of a fluidic diagram for dispensing CSD pods in series in accordance with the principles of the present disclosure.

FIG. 5a is a schematic of another fluidic diagram for dispensing CSD pods.

FIG. 6 is a cut away view of an example beverage pod cartridge in accordance with the principles of the present disclosure.

FIG. 7 is a schematic of a fluidic diagram with a central channel for dispensing CSD pods in parallel in accordance with the principles of the present disclosure.

FIG. 8 is a schematic of a fluidic diagram without a central channel for dispensing CSD pods in parallel in accordance with the principles of the present disclosure.

FIG. 9 is a schematic top view of a pod having two storage compartments in a parallel configuration with a central channel in accordance with the principles of the present disclosure.

FIG. 10 is a cross-sectional view of the pod shown in FIG. 9 taken along line 10-10.

FIG. 10a is a cross-sectional view of an alternative pod construction.

FIG. 10b is a cross-sectional view of another alternative pod construction.

FIG. 10c is a top view of the pod of FIG. 10b.

FIG. 10d is a cross-sectional view of another alternative pod construction.

FIG. 10e is a top view of the pod of FIG. 10d.

FIG. 11 is a cross-sectional view of the pod shown in FIG. 9 taken along line 11-11 including shuttle valves.

FIG. 12 is a cross-sectional view of the pod shown in FIG. 9 including actuating pins to actuate the shuttle valves.

FIG. 13 is a schematic top view of an alternative pod having four storage compartments in parallel configuration with a central channel in accordance with the principles of the present disclosure.

FIG. 14 is a schematic top view of the pod shown in FIG. 13 without a central channel.

FIG. 15 is a schematic top view of the pod shown in FIG. 9 without a central channel.

FIG. 16 is a cross-sectional view of the pod shown in FIG. 15 including shuttle valves and actuating pins.

FIG. 17 is a cross-sectional view of a pod including having a central channel and an add-on flavor pod in accordance with the principles of the present disclosure.

FIG. 18 is a schematic side view of an example of a pod with three storage compartments and an add-on pod in series in accordance with the principles of the present disclosure.

FIG. 19 is a cross-section of a pod with an add-on pod in series in accordance with the principles of the present disclosure.

FIG. 20 is a schematic top view of an example blister type pod in accordance with the principles of the present disclosure.

FIG. 21 is a schematic of a method of using the blister type pod shown in FIG. 20.

FIG. 22 is a multi-view of another alternative pod construction.

FIG. 22b is a multi-view of another alternative pod construction.

FIG. 23 is a multi-view of another alternative pod construction.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

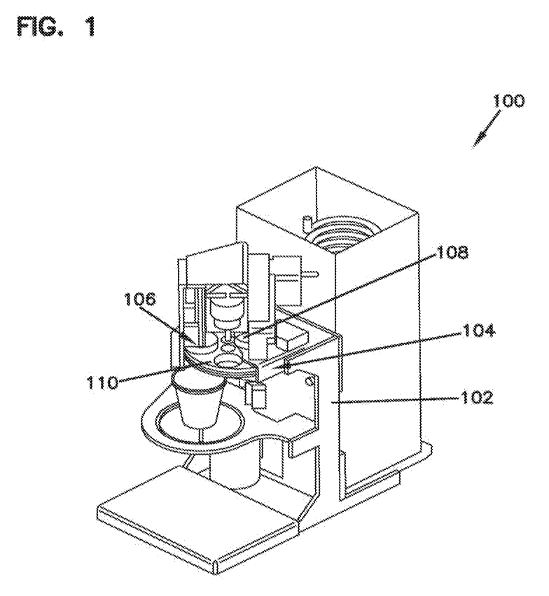

FIG. 1 is a perspective view of an example pod beverage dispenser 100 having a single dispensing head. The pod beverage dispenser 100 can be configured to dispense beverages using pods that have been inserted into the pod beverage dispenser 100. The elements of the example pod beverage dispenser 100 as a whole are mounted onto a dispenser frame 102. The dispenser frame 102 may be made out of stainless steel, aluminum, other types of metals, or other types of substantially non-corrosive materials. The beverage dispenser 100 may include a control system (not shown), a turret assembly 104, a dispensing station 106, an ejector assembly 108, and a loading assembly 110. The control system controls the flow of diluent within the beverage dispenser 100. The control system may also be used to control the flow of carbon dioxide within the beverage dispenser 100. An example of one control system, injector assembly, ejector assembly, and loading assembly is disclosed in U.S. Pat. Pub. No. 2005/0095158 A1, which is hereby incorporated by reference in its entirety.

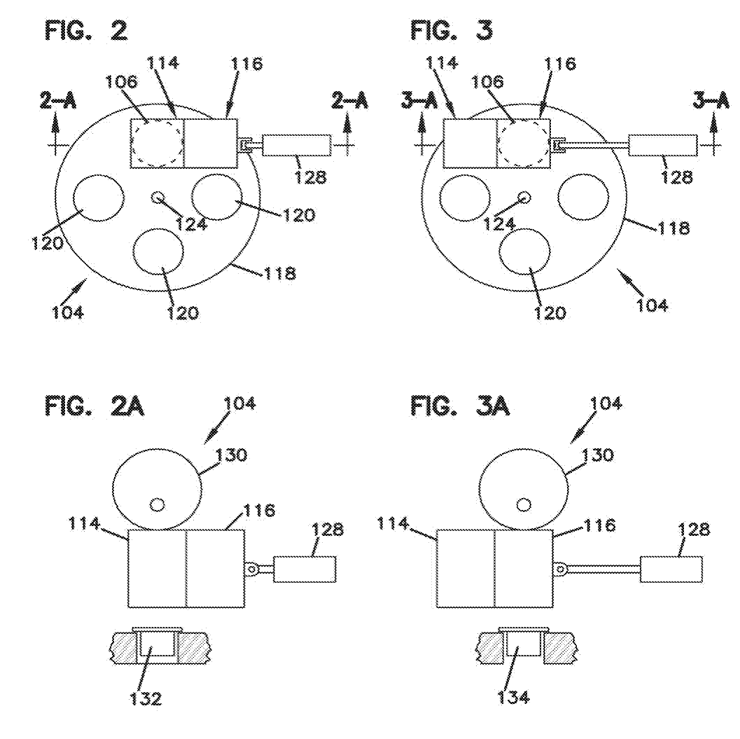

FIG. 2 illustrates details of the example turret assembly 104. In this example, a double head dispenser is shown.

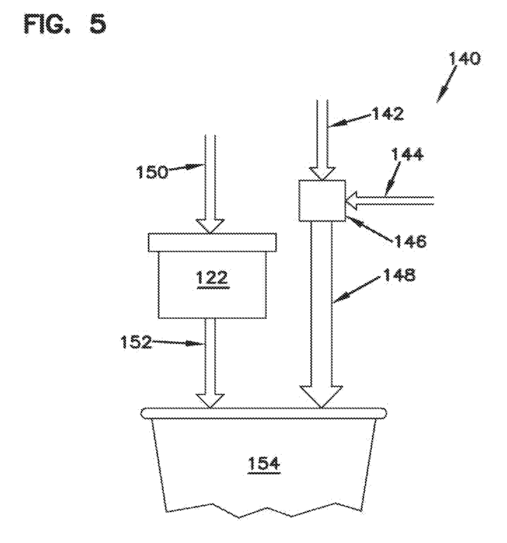

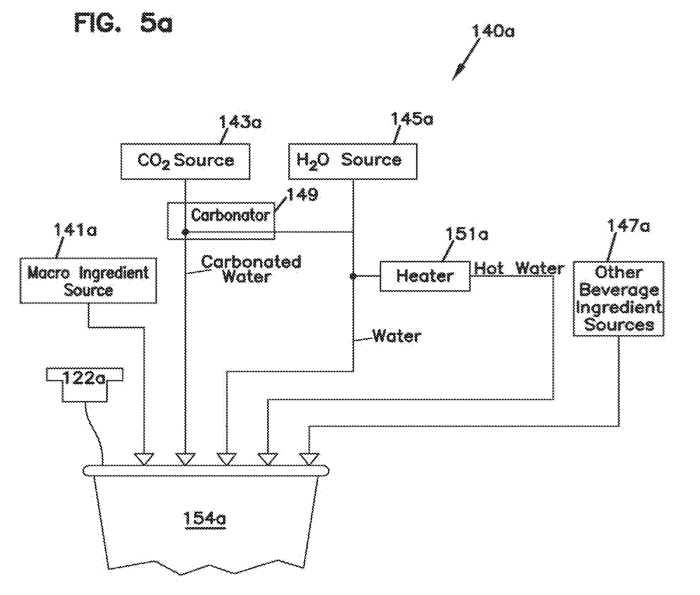

FIG. 2 is a top plan view of the example turret assembly 104. The example turret assembly 104 includes a hot beverage dispensing head 114 (e.g., coffee or tea) and a cold beverage dispensing head 116 (e.g., a carbonated soft drink (CSD)). It is to be understood that the hot beverage dispensing head 114 may be used to dispense any hot beverage and the cold beverage dispensing head 116 may be used to dispense any cold beverage. For example, the hot beverage dispensing head 114 may be configured to dispense hot water, hot milk, and/or other hot fluids through a beverage pod so as to dispense a hot beverage. Likewise, the cold beverage dispensing head 116 may be configured to dispense cold water, cold carbonated water, and/or other cold fluids through a beverage pod so as to dispense a cold beverage. The turret assembly 104 includes a turret plate 118. In this example, the turret assembly 104 is substantially circular. The turret plate 118 of the turret assembly 104 defines a plurality of apertures 120 for receiving a pod 122 (see FIG. 5). The turret assembly 104 includes a turret shaft 124 positioned and fixed about the center of the turret plate 118 such that the turret plate 118 may spin thereon.

The turret assembly 104 includes the example dispensing station 106 (see FIG. 1). It is understood that the arrangement and configuration of the example dispensing station 106 may vary in other embodiments. The example dispensing station 106 is a single dispensing station arranged and configured to dispense beverages via both the hot beverage dispensing head 114 and the cold beverage dispensing head 116. The hot beverage dispensing head 114 and the cold beverage dispensing head 116 can slide side-to-side so that either the hot beverage dispensing head 114 or the cold beverage dispensing head 116 is centered over the dispensing station 106. As shown in FIG. 2, the example dispensing station 106 is configured to receive hot fluids from the hot beverage dispensing head 114 such that the pod beverage dispenser 100 dispenses a hot beverage.

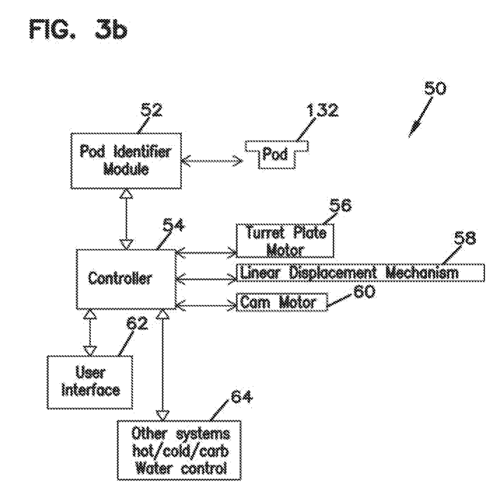

Referring to FIG. 3, the example single dispensing station 106 of the turret assembly 104 is shown configured to receive cold fluids from the cold beverage dispensing head 116 such that the pod beverage dispenser 100 dispenses a cold beverage. The linear displacement mechanism laterally moves the hot beverage dispensing head 114 and the cold beverage dispensing head 116 side-to-side is well known in the art. In this example, a pneumatic cylinder 128 is shown as providing the motive force. It is to be understood that any similar linear motion device may be used.

Referring to FIG. 2A, a cross-sectional view of a portion of the beverage dispenser shown in FIG. 2 taken along line 2A-2A is depicted which includes a cam 130 and a hot beverage pod 132. The hot beverage dispensing head 114 may operate in any orientation. In this example, the hot beverage dispensing head 114 is moved in position such that a hot beverage is dispensed from the pod beverage dispenser 100. The hot beverage pod 132 can include a brewable material such as coffee grounds, tea leaves, or the like or the hot beverage pod 132 can include a hot beverage concentrate such as a liquid concentrate, a powder, freeze-dried crystals, or the like. The hot beverage concentrate may be made from a previously brewed beverage or brewed beverage concentrate. Hot water or other hot fluids may be dispensed from the hot beverage dispensing head 114 through the hot beverage pod 132 to dispense a hot beverage, such as, but not limited to, a coffee, tea, etc.

Referring to FIG. 3A, a cross-sectional view of a portion of the beverage dispenser shown in FIG. 3 taken along line 3A-3A is depicted which includes the cam 130 and a cold beverage pod 134. In this example, the cold beverage dispensing head 116 is in position such that a cold beverage is dispensed from the pod beverage dispenser 100. The cold beverage dispensing head 116 may operate in any orientation. The cold beverage pod 134 can include liquid concentrate or powder for forming a non-carbonated or carbonated beverage. Cold water, cold carbonated water, or other cold fluids may be dispensed from the cold beverage dispensing head 116 through the cold beverage pod 134 to dispense a cold beverage, such as, but not limited to a juice, a tea, a soft drink, etc.

The cam 130 is a rotating or sliding piece in a mechanical linkage used to transform rotary motion into linear motion or vice-versa. In this example, the cam 130 is used to translate the dispensing head 114 towards and away from the pods. For example, upon rotating the cam 130 180 degrees, the dispensing head 114 is lowered onto the pod at the dispensing station with sufficient force so as to form a sealing engagement between the dispensing head 114 and the pod.

A cam motor may drive the cam 130. The cam motor may be a conventional AC motor or a similar type of device. In alternative designs, the cam can be replaced with other mechanisms that provide linear actuation, such as a pneumatic cylinder or a rack and pinion mechanism.

The beverage dispenser 100 may be configured to identify the type of pod 122 being inserted into the turret assembly 104. The configuration can include detecting a machine readable element on each pod, such as, but not limited to, a radio-frequency identification tag (RFID), that corresponds to a reading device in the beverage dispenser 100. In other examples the recognition system can includes barcodes, magnetic strips, optical recognition, microchips, and the like, including combinations thereof. In certain examples, the method for recognition may include physical obstructions, such as, but not limited to, voids, bumps, ridges, holes, recesses, protrusions, and the like, including combinations thereof.

In certain examples, upon insertion of the hot beverage pod 132 into the turret assembly 104, the hot beverage dispensing head 114 would automatically index to the dispensing station 106. Likewise, upon insertion of the cold beverage pod 134 into the turret assembly 104, the cold beverage dispensing head 116 would automatically index to the dispensing station 106. In this example, the user does not have to specify the type of pod 122 being inserted in the turret assembly 104 of the beverage dispenser 100 because all of the information regarding the pod type, ingredients therein, number of compartments within the pod, etc. will be recognized by the identification system. The pod 122 can be arranged and configured to be used within any type of pod beverage dispenser.

Referring to FIG. 3b, an example control system 50 for the pod beverage dispenser 100 is illustrated. Once a consumer places the hot beverage pod 132 into the turret assembly 104, a pod identifier module 52 can detect the type of beverage pod inserted in the turret assembly 104. As described above, the pod identifier module 52 may be a machine reader for reading one or more of an RFID tag, barcode, magnetic strip, optical symbol, microchip, and the like, such as, but not limited to, an RFID reader, a barcode reader, a magnetic strip reader, an optical sensor, or a microchip interface. An electronic controller 54 may monitor and control the operation of the pod beverage dispenser 100 as a whole and each of the components therein. The electronic controller 54 may be a microcontroller or a similar type of device. Once the identification of the hot beverage pod 132 is made, the electronic controller 54 may operate a turret plate motor 56, a linear displacement mechanism 58, and a cam motor 60. The correct pod compartment of the turret plate 118 may rotate into place and the hot beverage pod 132 may be dropped into the correct turret aperture 120 for the turret assembly 104.

In certain examples, the electronic controller 54 may be integrated with a user interface 62. In some embodiments, the user interface 62 may receive input from a consumer to identify the type of beverage pod inserted in the turret assembly 104. For example, the user interface 62 may receive selections of a pod on a user input screen or receive product code information provided on the pod packaging. In other examples, the electronic controller 54 may be integrated with other systems 64 (e.g., hot/cold/carbonated/water controls) for automatic dispensing.

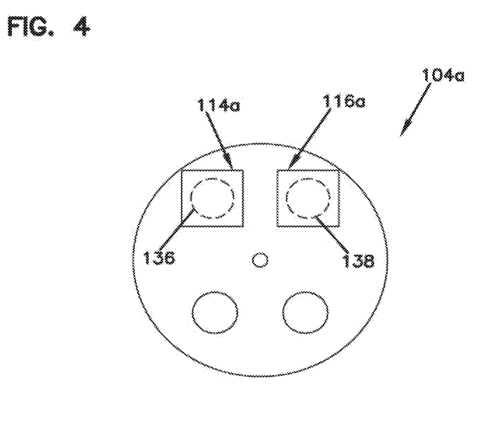

Referring to FIG. 4, an example alternative embodiment of a turret assembly 104a arranged and configured with two dispensing stations is illustrated. It is understood that the configuration of the two dispensing stations may vary in other embodiments.

In one example, the turret assembly 104a includes a first dispensing station 136 and a second dispensing station 138 for dispensing from a hot beverage dispensing head 114a and a cold beverage dispensing head 116a respectively. In other words, the first dispensing station 136 is dedicated to coffee or any hot beverage and the second dispensing station 138 is dedicated to any cold beverage. The hot beverage dispensing head 114a is positioned above the first dispensing station 136 and the cold beverage dispensing head 116a is positioned above the second dispensing station 138. Upon insertion of a hot beverage pod 132a the turret assembly 104a automatically indexes the hot beverage pod 132a to the first dispensing station 136 by rotating the turret plate 118 90°, for example. Similarly, upon insertion of a cold beverage pod 134a into the turret assembly 104a, the turret assembly 104a automatically indexes the cold beverage pod 134a to the second dispensing station 138 by rotating the turret plate 118 180°, for example. As described above, the control system 50 and a method for recognizing the type of pod inserted in the turret assembly 104a can be used. With two dispensing stations, the linear displacement mechanism 58 may not be present because the dispensing heads 114a, 116a may be laterally fixed over their respective dispensing stations 136, 138.

Referring to FIG. 5, a schematic of an example fluidic diagram 140 is illustrated for dispensing a beverage from the cold beverage pod 134.

The example fluidic diagram 140 includes a first diluent stream 142, a macro-ingredient stream 144, a mixing device 146, a mixed stream 148 exiting the mixing device 146, a second diluent stream 150 (e.g., ingredient transfer medium) entering the pod 122, and an ingredients stream 152 exiting the pod 122.

The macro-ingredient stream 144 typically has a viscosity and density much different from common diluents and must be thoroughly mixed to prevent stratification. In some embodiments, the macro-ingredient stream 144 may be a nutritive sweetener, such as, high fructose corn syrup (HFCS), liquid sucrose, an inverted sugar, or other such sweeteners. In some embodiments, the macro-ingredient stream 144 may be a non-sweetener beverage ingredient. The mixing device 146 can be a conventional dispensing nozzle well known to those in the art. The mixed stream 148 contains a mixture of the first diluent and the macro-ingredient stream 144 that is dispensed into a cup 154. The first diluent may be water, carbonated water, or other beverage diluents.

In one example, carbon dioxide (CO₂) gas is routed to the pod 122 to act as the ingredient transfer medium 150 to transfer the ingredients out of the pod 122 into the cup 154. The ingredients in the pod 122 can have a viscosity and density similarly to common diluents and may not be prone to stratification. In some embodiments, the ingredients in the pod 122 may include one or more beverage micro-ingredient. In some embodiments, the ingredients may be un-sweetened beverage ingredients, such as an unsweetened beverage micro-ingredient. The mixed stream 148 and the ingredients stream 152 dispensing in the cup 154 are parallel to each other.

In other embodiments, the mixed stream 148 and the ingredients stream 152 may be in one stream. In some examples, the ingredient transfer medium 150 may not be CO₂. In such examples, the mixed stream 148 of diluent and the macro-ingredient stream 144 are routed through the pod 122 and becomes the ingredient transfer medium 150 to dispense the ingredients from the pod 122.

In still other embodiments, the fluidic diagram 140 may include a secondary diluent stream that branches off the diluent stream 142 upstream or downstream of the mixing device 146. The secondary diluent stream may be used as the ingredient transfer medium 150.

Referring to FIG. 5a, another example of an example fluidic diagram 140a is illustrated for dispensing a beverage. In the illustration, the fluidic diagram 140a includes a pod 122a, a macro ingredient source 141a, a CO₂ source 143a, a H₂0 source 145a, and other beverage ingredient sources 147a. In the depicted illustration, ingredients from the pod 122a are being dispensed into a cup 154a. The CO₂ source 143a has a carbonator 149a that is used to generate carbonated water that is dispensed into the cup 154a. In some embodiments, the CO₂ source 143a may have a removable CO₂ cylinder. In one example, the H₂0 source 145a includes a heater 151a for generating hot water that can be dispensed in the cup 154a. In some embodiments, the water source 145a may include a removable water reservoir or a water supply line. Water that does not undergo heating from the heater 151a may also be dispensed into the cup 154a. In certain examples, other ingredient sources 147a (e.g., juice, dairy, milk, yogurt, etc.) may be dispensed to the cup 154a.

Ingredients that can be used in pods of the pod beverage dispenser 100 include: traditional beverage syrup (nutritive or non-nutritive sweetened), un-sweetened beverage concentrate, un-sweetened beverage micro-ingredient, un-sweetened acid and acid-degradable beverage flavor components, non-nutritive or high-intensity sweetener can be included in the acid-degradable flavor component. It is to be appreciated that other ingredient scenarios may be possible.

Various dispensing scenarios can be accomplished using the beverage dispensers and pods described herein. For example, one or more of the dispensing mechanisms described herein can be used to dispense either hot beverages (e.g., coffee, tea) or cold beverages (e.g., carbonated soft drinks). The pods used to accomplish both the hot and cold beverages can be similar in external geometries to allow for ease in the insertion into the beverage dispensers.

Further, the pods can be arranged in both serial (i.e., co-linearly) and parallel (i.e., perpendicularly or radially) configurations to accomplish different dispensing scenarios, as needed. In addition, add-on flavors can be arranged in series or parallel to increase the number of beverage dispensing choices. In addition, the pods can be used to deliver a macro ingredient or syrup, which is a beverage ingredient with a reconstitution ratio might be somewhere between 06:01 to 10:01.

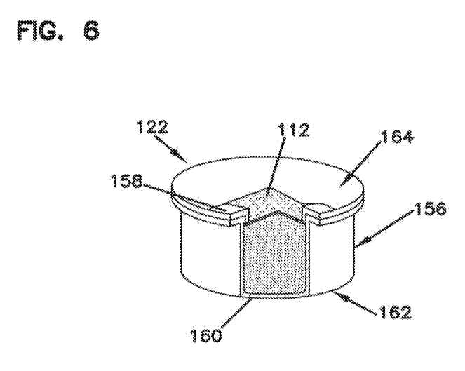

Referring to FIG. 6, one example embodiment of the pod 122 is illustrated. The pod 122 can include a cup 156, an insert 158, a filter layer 160, a bottom seal 162, and a top seal 164. Further details about an example pod are disclosed at U.S. Patent Publication No. 2005/0095158 A1, which was previously incorporated by reference herein.

The cup 156 can be made out of a conventional thermoplastic such as polystyrene or polyethylene. It will be appreciated that the cup 156 can be made out of metal, such as, but not limited stainless steel, or similar types of substantially noncorrosive materials.

The insert 158 encloses the top of the cup 156. The insert 158 may be made out of a thermoplastic or a similar material as is used for the cup 156. The insert 158 defines a plurality of apertures 112 such that in use fluid passes over and through the apertures 112 into the cup 156. In other examples, the pod may not include the insert 158 such that fluid flows directly into the cup 156 from the top of the pod 122.

The top seal 164 encloses the cup 156 to provide an airtight seal for the ingredients contained within the pod 122. The top seal 164 can be made out of a foil or similar type of substantially airtight material.

The bottom seal 162 is arranged and configured to enclose the bottom end of the cup 156. The bottom seal 162 may include the filter layer 160. The bottom seal 162 can be made out of foil or similar material as is used for the top seal 164. The top and bottom seals 162, 164 may keep the ingredients within the pod 122 in a substantially airtight manner for freshness purposes. The filter layer 160 may be made out of a paper filter material or similar types of material. In other examples, the pod 122 may not include the filter layer 160.

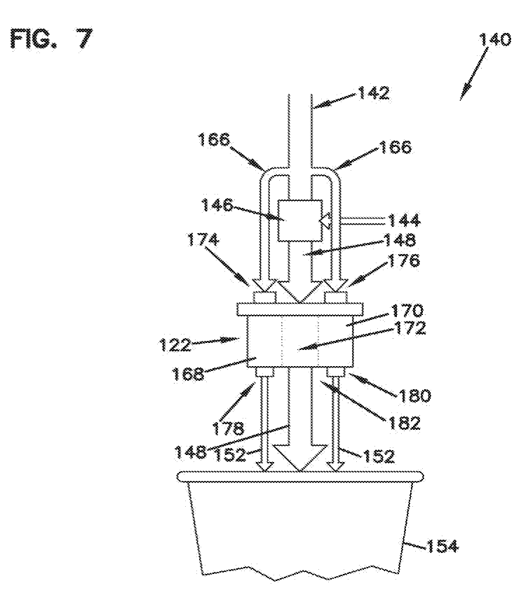

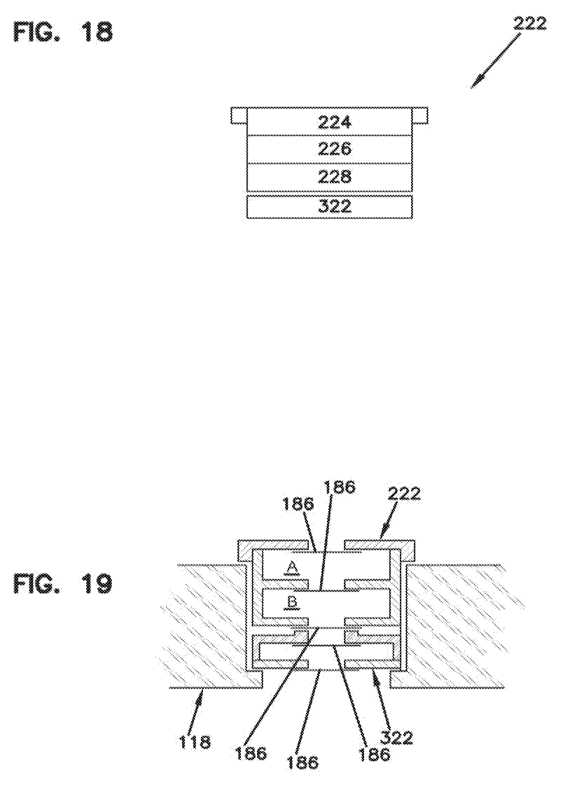

The pod 122 can be arranged and configured with various storage compartments that can each include an ingredient. The storage compartments of the pod 122 can be constructed in either a parallel configuration or a series configuration. In a parallel configuration (see FIGS. 7-9), ingredients are stored in the pod so that a diluent generally dilutes each ingredient at the same time. In a series configuration (see FIGS. 18-19), the ingredients are stored in the pod so that the diluent generally dilutes each ingredient sequentially. Other configurations are possible, such as pods having both parallel and series configurations.

The pod 122 may be filled with various combinations of ingredients. A few of the various ingredients used in the pods 122 are macro ingredients, such as non-nutritive sweetener or nutritive sweetener (i.e. sugar syrup or HFCS). The macro-ingredient can have a reconstitution ratio of less than 10:1. In some examples, the macro-ingredient may have a reconstitution ratio between about 3:1 to about 6:1. The pods 122 can also include micro ingredients, such as, natural and artificial flavors, natural an artificial colors, and acid and non-acid components of flavoring. The micro-ingredient can have a reconstitution ratio greater than or equal to 10:1. These ingredients may include acids, flavors and high-intensity or non-nutritive sweeteners. It will be appreciated that any number of ingredient combinations can be used in pods 122 along with multiple compartment configurations.

Referring to FIG. 7, a schematic of the example fluidic diagram 140 is illustrated with secondary diluent streams 166. The secondary diluent streams 166 are routed to the pod 122. In one example, the pod 122 has a first ingredient storage compartment 168, a second ingredient storage compartment 170, and a central channel 172 which are constructed in a parallel configuration. The secondary diluent streams 166 enter each of the first and second ingredient storage compartments 168, 170 of the pod 122 respectively via a first inlet port 174 and a second inlet port 176. The secondary diluent streams 166 flow through and exit the pod 122 via a first outlet port 178 and a second outlet port 180. As discussed above, the diluent stream 142 and the macro-ingredient stream 144 may mix in the mixing device 146 to produce the mixed stream 148. The secondary diluent streams 166 act as the ingredient transfer medium 150 to transfer the ingredients within the first and second ingredient storage compartments 168, 170 to the cup 154 via ingredient streams 152. The mixed stream 148 flows through a central channel 172 in the pod 122. The mixed stream 148 and the ingredient streams 152 mix within the cup 154 to form the beverage or finished beverage. In some examples, the mixing device 146 may be downstream of the pod 122.

In other embodiments, the secondary diluent stream 166 may be carbonated or CO₂ streams. The CO₂ streams can each be routed to the pod 122 as described above.

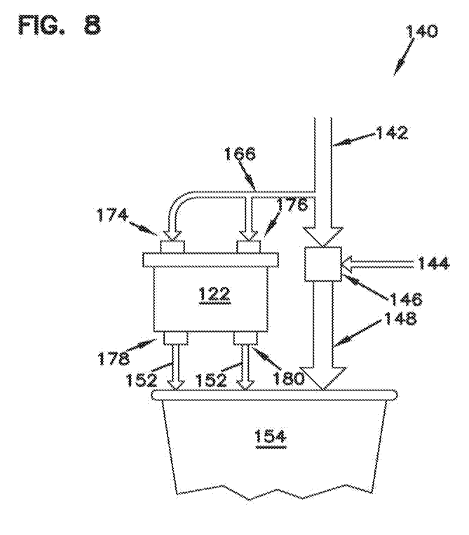

Referring to FIG. 8, the example fluidic diagram 140 is depicted such that the pod 122 does not include a central channel 172 for accommodating the mixed stream 148. In this example, the diluent stream 142 enters the mixing device 146 and is mixed with the macro-ingredient stream 144 to form the mixed stream 148. The mixed stream 148 is then dispensed into the cup 154. The secondary diluent streams 166 may be branched off from the diluent stream 142 to enter the pod 122 similarly as described above with reference to FIG. 7. The ingredients streams 152 are then dispensed into the cup 154 along with the mixed stream 148.

In other examples, the secondary diluent streams 166 can be used to initially dispense the ingredients from the pod 122. At the end of the dispense, the secondary diluent streams 166 can be shut off to allow CO₂ to be routed to the pod 122 to blow out any remaining diluent or ingredients in the pod 122.

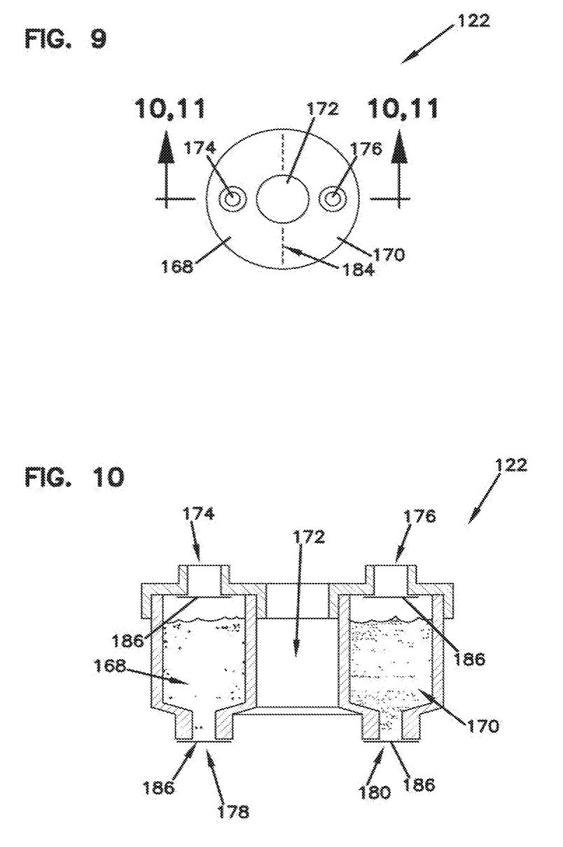

Referring to FIG. 9, a top schematic view of the pod 122 with a parallel configuration is illustrated. The pod 122 is arranged and configured with internal compartment dividers 184 to separate the first and second ingredient storage compartments 168, 170. The compartment dividers 184 may optionally contain filter media. In the depicted example, the pod 122 includes the central channel 172 to accommodate the mixed stream 148. The pod ingredients are stored in internal compartments 168, 170 spaced surrounding the central channel 172. As shown, there are two ingredient storage compartments. It will be appreciated that there could be any number of ingredient storage compartments.

Referring to FIG. 10, a cross-sectional view of the pod 122 shown in FIG. 9 is depicted. The pod 122 includes the first and second outlet ports 178, 180 for the first and second ingredient storage compartments 168, 170. In this example, the first and second inlet ports 174, 176 and the first and second outlet ports 178, 180 are each sealed with a rupturable membrane 186. When a dispensing head lowers onto the pod 122, tubes channeling an ingredient transfer medium can be sealed over the inlet ports 174, 176. In another embodiment, a tube channeling a main diluent stream can be inserted into the central channel 172 of the pod 122. Pressure from the ingredient transfer medium first ruptures the rupturable membranes 186 covering the first and second inlet ports 174, 176. Subsequently, the rupturable membranes 186 covering the first and second outlet ports 178, 180 are ruptured. The ingredient transfer medium flows through the first and second ingredient storage compartments 168, 170 driving the ingredients out of the pod 122.

Referring to FIG. 10a, an alternate pod 122b construction is shown. In the depicted embodiment, the pod 122b is shown including the first and second ingredient storage compartments 168b, 170b. In use, a consumer removes the top and bottom seals 162b, 164b prior to placing the pod 122b in the dispenser. Rupturable membranes 186b are positioned at the inlet and outlet ports of each of the ingredient storage compartments 168b, 170b. When a diluent enters the inlets, the pressure from the diluent stream causes the rupturable membranes 186b to erupt allowing the ingredients to flow therefrom. In one example, the construction of the pod 122b can be shipped or delivered as-is.

Referring to FIG. 10b, an alternate pod 122c is shown. The pod 122c can be constructed with an area of weakening 189 that functions as a built-in rupturable wall. The area of weakening 189 can be configured to erupt similar to rupturable membranes 186 upon application of pressure.

FIG. 10c is a top view of the alternate pod 122c shown in FIG. 10b. The configuration of the alternate pod 122c provides for a two-part construction. As shown, the area of weakening 189 may have x-shaped or other shaped embossment to promote rupturing in desirable patterns upon application of pressure.

Referring to FIG. 10d, another alternate pod 122d is shown. In the depicted example, the pod 122d defines an area of weakening 189a. The area of weakening 189a can be formed from a one-part construction of the pod 122d.

Referring to FIG. 10e, a top view of the pod 122d in FIG. 10d is shown. As described above, the area of weakening 189a may have an x-shaped or other shaped embossment to promote rupturing in desirable patterns upon application of pressure.

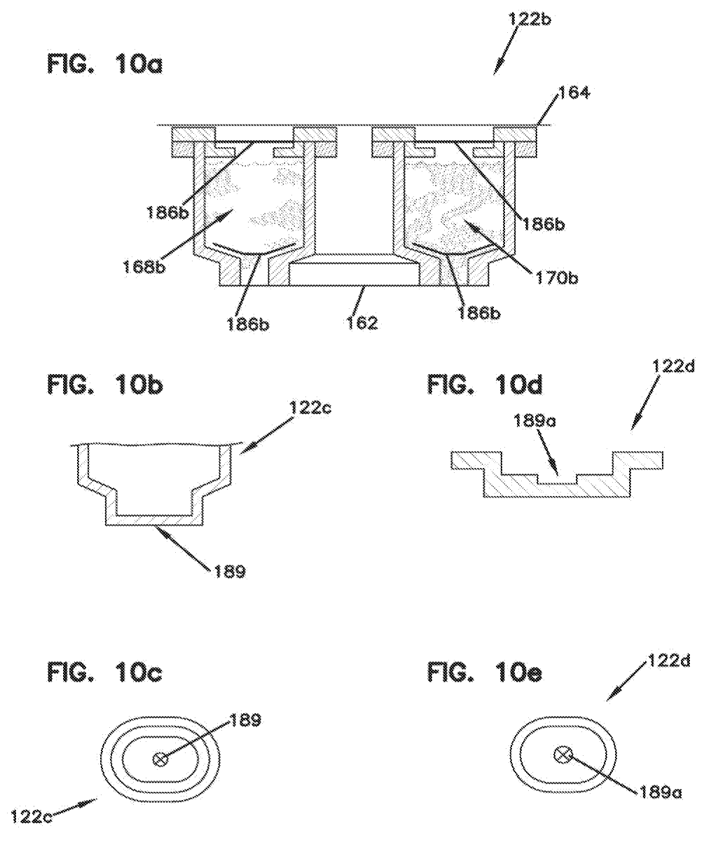

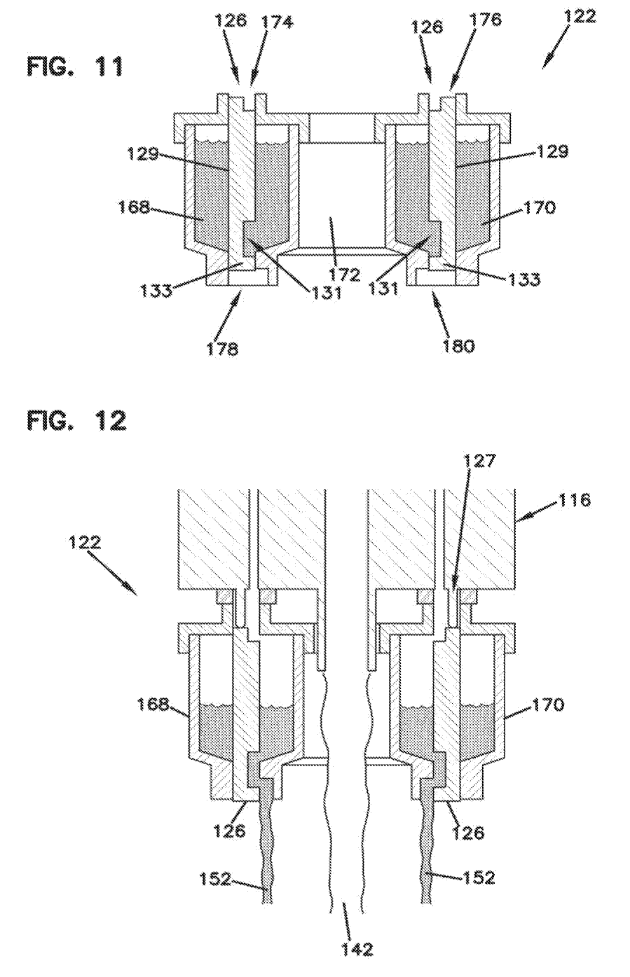

Referring to FIG. 11, a cross-sectional view of the pod 122 shown in FIG. 9 is depicted including shuttle valves 126. The shuttle valves 126 are arranged and configured to seal the first and second inlet ports 174, 176 and the first and second outlet ports 178, 180 of each of the first and second ingredient storage compartments 168, 170 respectively. In one embodiment, the shuttle valves 126 can include an elongated body 129 that extends between the inlet ports 174, 176 and the outlet ports 178, 180 of the ingredient compartments 168, 170. In one embodiment, the elongated body 129 of the shuttle valves 126 defines a notch 131 to guide the flow of ingredients out of the pod 122. In other embodiments, the shuttle valves 126 may include a horizontal member 133 that extends from one end of the elongated body 129 to help seal the outlet ports 178, 180 of the ingredient compartments 168, 170. In certain examples, the elongated body 129 can be integrated together with the horizontal member 133 to form one piece.

Referring to FIG. 12, the shuttle valves 126 can each be actuated by actuation pins 127 that pushes the shuttle valves 126 downward simultaneously opening all of the first and second inlet ports 174, 176 and the first and second outlet ports 178, 180. In other examples, the shuttle valves 126 can be actuated by the pressure of the ingredient transfer media instead of by the actuation pins 127. The ingredient transfer media drives the ingredients out of the pod 122. In certain examples, the shuttle valves 126 and the first and second outlet ports 178, 180 can be arranged and configured to direct the flow of the ingredient streams 152 for each respective storage ingredient chamber into the diluent stream 142 to aid in mixing. As depicted, the notch 131 defined by the shuttle valves 126 help to guide the flow of the ingredient streams 152 out of the pod 122.

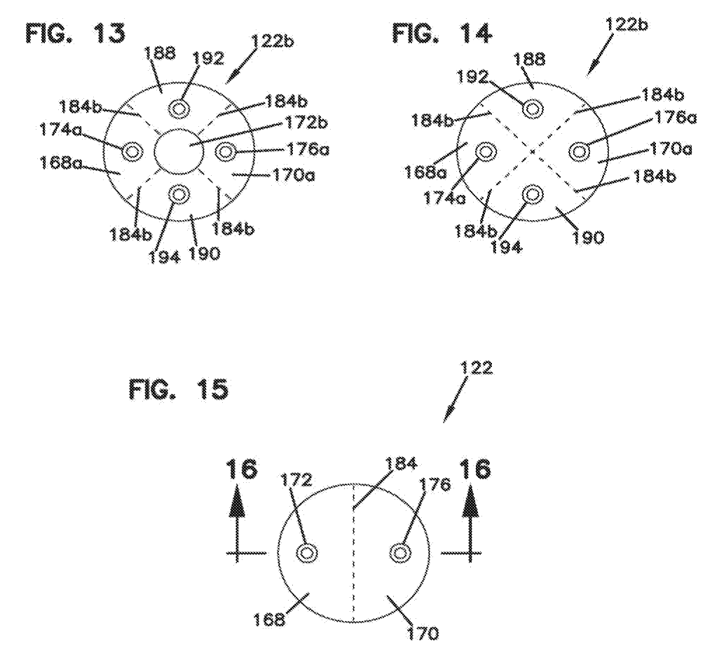

Referring to FIG. 13, a schematic top view of an example pod 122b is depicted. The pod 122b includes a first ingredient storage compartment 168a, a second ingredient storage compartment 170a, a third ingredient storage compartment 188, and a fourth ingredient storage compartment 190. Each of the first, second, third, and fourth ingredient storage compartments 168a, 170a, 188, 190 are separated by a compartment divider 184b. The first, second, third, and fourth ingredient storage compartments 168a, 170a, 188, 190 are arranged and configured with a first, second, third and fourth inlet port 174a, 176b, 192, and 194 respectively. The example pod 122b further includes a central channel 172b. FIG. 14 is an illustration of the example pod 122b without the central channel 172b. Each of the compartments is shown in FIGS. 13 and 14 as being about the same size. In some examples, one or more of the compartments may have different sizes/volumes.

Referring to FIG. 15, a top view of the example pod 122 with a parallel configuration depicted in FIG. 9 is illustrated without the central channel 172. In certain embodiments, a dispensing head may be lowered onto the pod 122. Tubes channeling a main diluent stream can be sealed over the inlet ports of the pod 122. When dispensing begins, the main diluent stream can flow unimpeded through the pod 122.

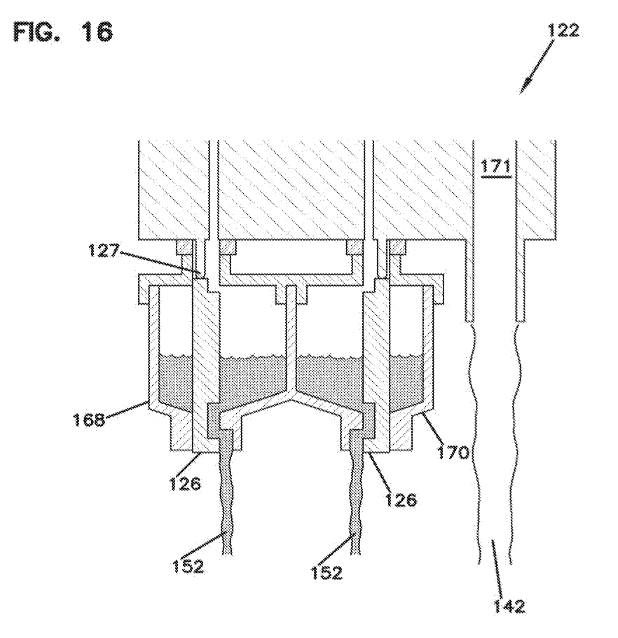

Referring to FIG. 16, a cross-sectional view of the example pod 122 shown in FIG. 15 is depicted. The pod 122 having a parallel configuration is illustrated with the shuttle valves 126 and actuation pins 127 as described above. As shown, a side channel 171 is included with the pod 122. Similar to the central channel 172, the side channel 171 may be used to provide for a diluent. As described above, a dispensing head may be lowered onto the pod 122. Tubes channeling an ingredient transfer medium can be sealed over the inlet ports of the pod 122. A tube channeling a main diluent stream may be inserted into the side channel 171 to allow the diluent stream 142 to flow therethrough into a cup.

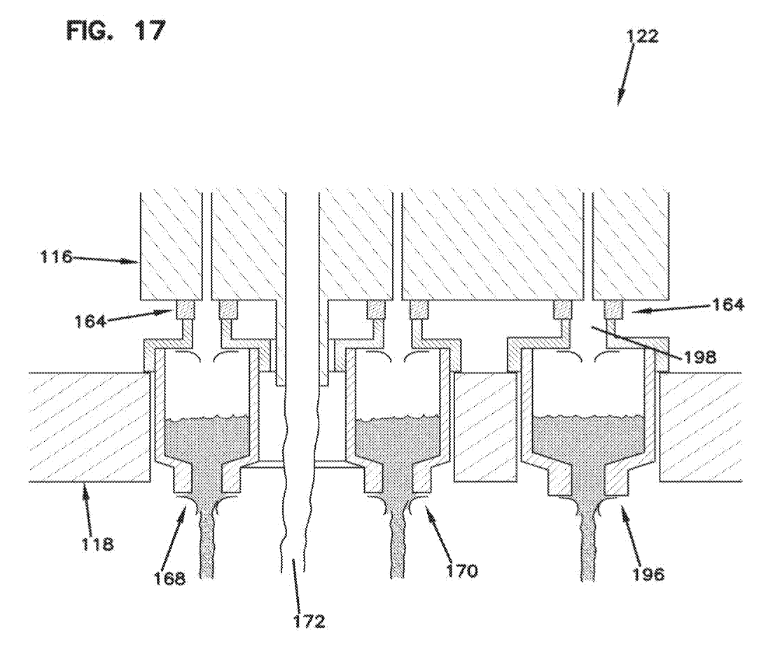

Referring to FIG. 17, a cross-sectional view of the example pod 122 with the central channel 172 and a separate pod 196. The separate pod 196 may contain an add-on flavor, such as, but not limited to, cherry, vanilla or raspberry flavors. The add-on flavor can be dispensed in parallel to the ingredients in the first and second ingredient storage compartments 168, 170. In some examples, the dispenser detects the presence of the separate add-on flavor pod with a limit switch-like device or with a light source/light sensor, where the add-on flavor pod would break the light beam. In other examples, no detection is necessary, as the dispenser can operate the same either with or without the add-on flavor. The add-on flavor is simply added on top of all of the other ingredients.

The turret plate 118 can be modified to accommodate the separate pod 196 containing the add-on flavor. The cold beverage dispensing head 116 includes a separate inlet port 198 for transferring an ingredient transfer medium to the separate pod 196. The transfer medium transfers the ingredients out of the separate pod 196.

Referring to FIG. 18, an example pod 222 is shown with ingredient storage compartments arranged and configured in series. The example pod 222 is a multi-ingredient pod that can be arranged co-linearly with a diluent flow so as to discharge the ingredients contained in the compartments sequentially. In the illustrated example, there is a first ingredient storage compartment 224, a second storage ingredient compartment 226, and a third ingredient storage compartment 228 stacked together one on top of the other. It will be appreciated that the pod 222 can include any number of ingredient storage compartments.

In one example, the example pod 222 can be a cold beverage type pod having ingredient storage compartments 224, 226, 228. The ingredient storage compartments 224, 226, 228 can include macro-ingredients, such as non-nutritive sweetener or nutritive sweetener (i.e. sugar syrup or HFCS). The ingredient storage compartments 224, 226, 228 can also include micro ingredients, such as, natural and artificial flavors, natural an artificial colors, and acid and non-acid components of flavoring. A diluent such as CO₂ or water can be used to transfer the ingredients out of the pod 222. In other examples, the diluent may include a sweetener, acid flavor components, or non-acid flavor components.

In one example, the example pod 222 can include an add-on flavor pod 322. The add-on flavor pod 322 is added serially to the example pod 222. The add-on flavor pod 322 can include flavors such as, but not limited to, cherry, vanilla, or raspberry. The add-on flavor can be mixed with the main ingredients in the pod 222 to create a flavored beverage.

Referring to FIG. 19, the example pod 222 and the add-on flavor pod 322 are illustrated in the turret plate 118. The turret plate 118 may include a number of apertures 120 therein. The apertures 120 may be sized to accommodate the pod 122. An example turret assembly and turret plate is disclosed at U.S. Patent Publication No. 2005/0095158 A1 herein incorporated by reference in its entirety. As shown, the example pod 222 includes two ingredient storage compartments A, B. The ingredient storage compartments A, B are separated by the rupturable membrane 186. The rupturable membrane 186 separates the ingredients within each compartment A, B until dispensing. It will be appreciated that the pod 222 may include any number of ingredient storage compartments. In one example, the add-on flavor pod 322 can be inserted in the turret plate 118 first followed by the pod 222 for a carbonated soft drink. In such situations, the add-on flavor pod 322 and the pod 222 are stacked one on top of the other. Rupturable membranes 186 may be used to seal the inlet and outlet ports of the pod 222 and inlet and outlet ports of the add-on flavor pod 322. When a dispensing head is placed on the pod 222, pressure from a diluent stream causes the rupturable membranes 186 of the pod 222 and add-on flavor pod 322 to break allowing the ingredients in each pod 222, 322 to flow therefrom into a cup.

In other examples, the add-on flavor pod 322 may not be included. The add-on flavor may be included in the pod 222 as a separate ingredient storage compartment. Thus, it is not necessary to include multiple pods that are stacked together in series because a single pod can be configured to include a multiple number of ingredient storage compartments.

When the cold beverage dispensing head 116 lowers onto the pod 222, the tube containing the transfer medium (i.e. diluent) creates a seal against a first inlet port 274 of the pod 222. The downward force generated by the cold beverage dispensing head 116 also seals a first outlet port 278 of the pod 222 to an inlet port 374 of the add-on flavor pod 322. The add-on flavor pod 322 can become an additional internal chamber associated with the pod 222 and can function as such during dispensing.

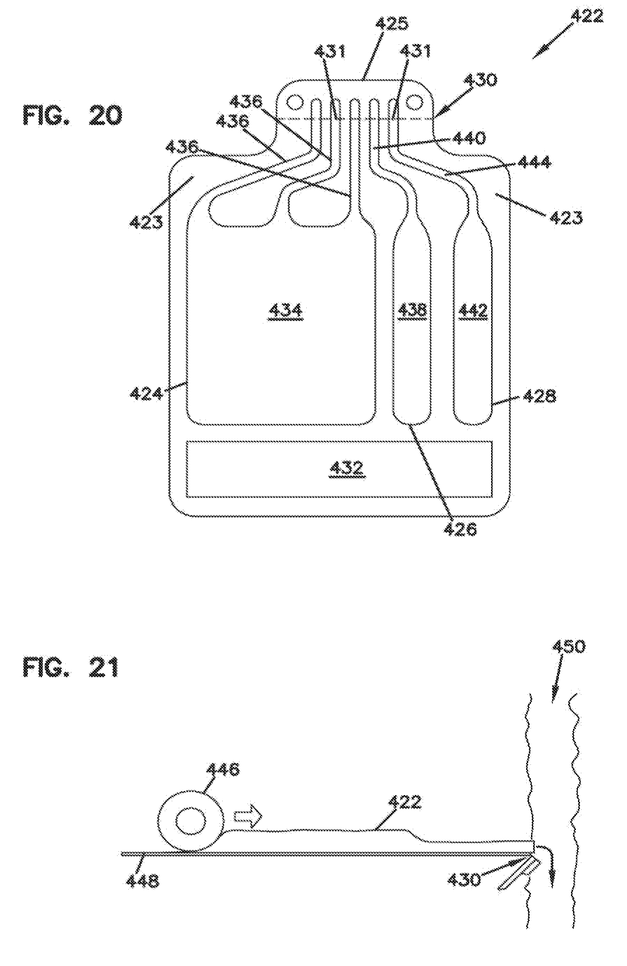

Referring to FIG. 20, an alternative example cold beverage pod 422 is illustrated. The cold beverage pod 422 includes a plastic sheet 423, which can be formed of molded, resiliently deformable, synthetic plastics, such as, e.g., polyvinyl chloride (PVC) or aluminum laminates (polyamide/aluminum/PVC) and/or shells, with a pre-configured array of multiple discrete pockets (or blisters), with an array of pre-formed discrete pockets or compartments. The cold beverage pod 422 can be backed by a layer of metal foil (i.e. aluminum foil), metallized plastics foil, or a laminated paper and foil combination. The backing can be of paperboard or a “lidding” seal of plastic. The cold beverage pod 422 can have structural integrity that allows for exceptional sealing.

The cold beverage pod 422 can have a triangular profile, apex outward or a rectangular profile. The cold beverage pod 422 can have a concave curved outer edge profile. In the depicted example, the cold beverage pod has a square profile with a tab extending end 425 for terminating the array of pockets. It will be appreciated that the cold beverage pod 422 can vary in shape and size. In certain examples, the cold beverage pod 422 can be arranged as a multiple pack stacked together and perhaps staggered, or marginally offset laterally.

The cold beverage pod 422 includes a first storage ingredient compartment 424, a second storage ingredient compartment 426, a third storage ingredient compartment 428, perforations 430, and a label 432. The example cold beverage pod 422 can be constructed similarly to conventional blister packs of pre-formed plastic packaging. The blister pack can include a cavity or pocket made from a “formable” web, usually a thermoformed plastic, to contain ingredients.

The first storage ingredient compartment 424 can include a macro-ingredient. The macro-ingredient can be a nutritive sweetener (i.e. sugar syrup, HFCS or liquid sucrose). The macro-ingredient can have a reconstitution ratio of less than 10:1.

The first storage ingredient compartment 424 can be integrally formed with the thermoformed plastic to form one piece. The first storage ingredient compartment 424 can be shaped in a tube array. In the depicted example, the first storage ingredient compartment 424 includes a body 434 and flow lines 436. The body 434 can be a pocket or cavity like body that contains the ingredients. The ingredients in the body 434 can be transferred out thereof through the flow lines 436. The method of transferring the ingredients out of the body 434 through the flow lines 436 will be described below in more detail with reference to FIG. 21.

The second and third ingredient storage compartments 426, 428 can each include a micro-ingredient such as, natural and artificial flavors, natural an artificial colors, and acid and non-acid components of flavoring. The micro-ingredient can have a reconstitution ratio greater than 10:1.

Similarly to the first storage ingredient compartment 424, the second and third ingredient storage compartments 426, 428 can be integrally formed with the thermoformed plastic to form one piece. Each of the second and third ingredient storage compartments 426, 428 can be shaped in a tube array. It will be appreciated that the ingredient storage compartments 424, 426, 428 of the cold beverage pod 422 can vary in shape.

In one example, the second ingredient storage compartment 426 can include a body 438 and a flow line 440. The third ingredient storage compartment 428 can include a body 442 and a flow line 444. Each of the bodies 438, 442 can be a pocket or cavity like body that contains the ingredients. The ingredients in each of the bodies 438, 442 can be transferred out thereof through flow lines 440, 444 respectively.

The cold beverage pod 422 can be pre-scored or folded, and pre-perforated. Multiple perforations 430 may be produced by a punch tool, such as a needle profile platen or rotary needle. The perforations 430 are formed in the backing layer across the tab extending end 425 of the cold beverage pod 422. A score 431 is shown across each of the flow lines 436, 440, and 444. When the backing sheet (not shown) is folded at the perforations 430, each flow line 436, 440, 444 will snap open simultaneously at the score 431 thereon exposing the ingredient in the body 434, 438, 442 of the respective ingredient storage compartment 424 426, 428.

In certain examples, a printing station (not shown) may be employed, to add identification graphics such as the label 432 including, but not limited to, local date/time, content and batch code.

Referring to FIG. 21, a method of dispensing the ingredients from the cold beverage pod 422 is illustrated. A pressure application device (i.e. roller) 446 and a rigid platform 448 are illustrated. The cold beverage pod 422 is laid flat against the rigid platform 448 with the tab extending end 425 facing a diluent stream 450. The pressure application device 446 is positioned adjacent to the rigid platform 448 opposite the tab extending end 425. Upon dispensing, the pressure application device 446 traverses the rigid platform 448 crushing the respective ingredient in the bodies 434, 438, 442 to transfer the ingredients out of the ingredient storage compartments 424 426, 428 into the diluent stream 450.

In other embodiments, the ingredients can be transferred out of a pod by applying a squeeze of the pod. This can be done by the hand of the user or some other mechanism.

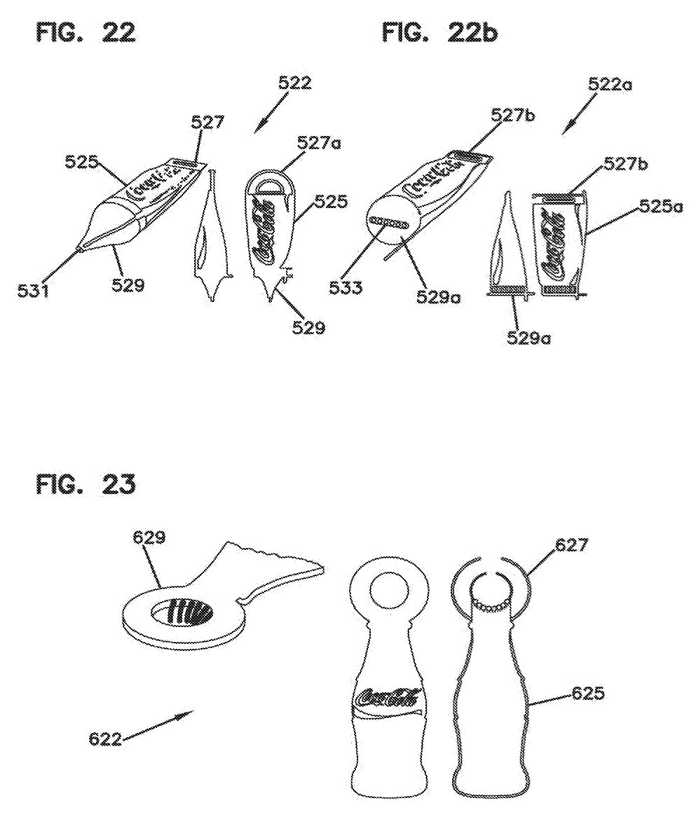

Referring to FIG. 22, another example pod 522 is shown. The pod 522 may be constructed to have a tube shaped body 525. The tube shaped body 525 may be configured similar to conventional tubes used for toothpaste or a likeness thereof. The tube shaped body 525 of the pod 522 may include a handle 527 at one end of the pod 522 and a closure 529 at the other end of the pod 522. The handle 527 may have a squared shape or a semi-circular shape. The handle 527 can be used for easy handling. It is appreciated that the shape of the handle 527 may vary with other embodiments. The closure 529 can include a single spout 531 to direct a stream of ingredients therefrom. Similar to the method shown in FIG. 21, the single spout 531 may be positioned to impinge on the diluent stream 450.

Referring to FIG. 22b, another example pod 522a is shown having a body 525a. The pod 522a includes a handle 527b and a closure 529a. The closure 529a defines a plurality of apertures 533. The ingredients may be transferred out of the pod 522a by squeezing the pod 522a, for example, by the pressure application device 446. The closure 529a can be used to direct a stream of ingredients through the plurality of apertures 533. Similar to the method shown in FIG. 21, the plurality of apertures 533 may be positioned to impinge on the diluent stream 450.

Referring to FIG. 23, another example pod 622 is shown. The example pod 622 includes a body 625 and a ring top 627. In the depicted example, the body 625 is shaped like a bottle. The ring top 627 of the pod 622 may define a plurality of openings 629. The plurality of openings 629 of the ring top 627 provides for a stream of ingredients to flow out of the pod 622 when the pod 622 is squeezed, for example, by the pressure application device 446. Similar to the method shown in FIG. 21, the diluent stream 450 may flow through the ring top 627 so as to impinge on the streams of ingredients flowing out of the pod 622.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A cartridge for use in a beverage dispenser, the cartridge comprising:
a plurality of storage compartments stacked in series within an interior of the cartridge, each of the plurality of storage compartments including: an inlet port, an outlet port opposite the inlet port, an ingredient contained between the inlet and outlet ports, and a seal covering the inlet and outlet ports;
wherein the cartridge is configured to allow a transfer medium to rupture the seal of each of the storage compartments and to enter the inlet port to dilute the ingredient in each of the plurality of storage compartments in series and to discharge the diluted ingredients out of the cartridge.

2. The cartridge of claim 1, wherein the seal is a rupturable membrane.

3. The cartridge of claim 1, wherein the seal is a shuttle valve.

4. The cartridge of claim 1, wherein the transfer medium is a diluent stream.

5. The cartridge of claim 4, wherein a flowing beverage formed by interaction of the diluent stream with the ingredient contained in each of the plurality of storage compartments flows through to the outlet port.

6. The cartridge of claim 1, further comprising an add-on cartridge in series.

7. The cartridge of claim 1, wherein the ingredient in one of the plurality of storage compartments is selected from a group consisting of: high fructose corn syrup, non-nutritive sweetener, artificial flavors, acids, natural flavors, and mixtures thereof.

8. The cartridge of claim 1, wherein the plurality of storage compartments are separated by internal dividers.

9. The cartridge of claim 1, further comprising an identification signal to identify a type of beverage being dispensed.

10. The cartridge of claim 9, wherein the identification signal includes one or more of a RFID tag, barcodes, magnetic strips, optical recognition, microchips, and combinations thereof.

11. A beverage dispenser comprising:
a cartridge including a plurality of storage compartments stacked on top of one another, each of the plurality of storage compartments including:
an inlet port;
an outlet port opposite the inlet port;
an ingredient contained between the inlet and outlet ports; and
a seal covering the inlet and outlet ports;
a turret including a first station for dispensing the cartridge;
a first dispensing head; and
a second dispensing head adjacent to the first dispensing head;
wherein the first and second dispensing heads are arranged and configured to move laterally such that one of the first and second dispensing heads is positioned over the first dispensing station for dispensing therefrom.

12. The beverage dispenser of claim 11, further comprising a second dispensing station.

13. The beverage dispenser of claim 12, wherein the first dispensing head is positioned over the first dispensing station for dispensing therefrom, and the second dispensing head is positioned over the second dispensing station for dispensing therefrom.

14. The beverage dispenser of claim 12, wherein the first dispensing head dispenses hot beverages and the second dispensing head dispenses cold beverages.

15. The beverage dispenser of claim 14, wherein the hot beverages are coffee or tea.

16. The beverage dispenser of claim 14, wherein the cold beverages are carbonated soft drinks.

17. The beverage dispenser of claim 12, wherein the cartridge further comprises an identification signal to identify a type of cartridge being dispensed, such that the turret indexes the cartridge to the corresponding first or the second dispensing station.

18. The beverage dispenser of claim 17, wherein the identification signal includes one or more of a RFID tag, barcodes, magnetic strips, optical recognition, microchips, and combinations thereof.

19. The beverage dispenser of claim 11, further comprising a mixing device, a first diluent stream, and a nutritive sweetener stream, wherein the first diluent stream and the nutritive sweetener stream are mixed together in the mixing device forming a transfer medium.

20. The beverage dispenser of claim 19, wherein the mixing device is a dispensing nozzle.

21. The beverage dispenser of claim 19, wherein the transfer medium is used to transfer the ingredient within each of the plurality of storage compartments out of the cartridge thereof to form a beverage.

22. The beverage dispenser of claim 19, further comprising a second diluent stream branching off the first diluent stream, wherein the second diluent stream transfers the ingredient within each of the plurality of storage compartments out of the cartridge into a cup.

23. The beverage dispenser of claim 22, wherein the transfer medium mixes with the second diluent stream in the cup to form a beverage.

24. The beverage dispenser of claim 11, wherein the storage compartments of the cartridge are positioned both in series and in parallel.

25. The beverage dispenser of claim 11, further comprising a plurality of cartridges positioned in series.
